(19) United States
(12) Patent Application Publication
(10) Pub. No.: US 2013/0024223 A1
(43) Pub. Date: Jan. 24, 2013

(54) SYSTEM AND METHOD FOR MANAGEMENT OF ELECTRONIC WALLET DATABASES

(71) Applicant: David William Thomas, Toronto (CA)

(72) Inventor: David William Thomas, Toronto (CA)

(73) Assignee: OMNEGO INC., Toronto, ON (CA)

(21) Appl. No.: 13/639,468

(22) PCT Filed: Apr. 6, 2010
(86) PCT No.: PCT/CA2010/000517

§ 371 Date: Oct. 4, 2012

Related U.S. Application Data
(60) Provisional application No. 61/320,880, filed on Apr. 5, 2010.

(51) Int. Cl. G06Q 20/36; G06Q 10/02; G06Q 30/02

(52) U.S. Cl. 705/5; 705/41; 705/14.4; 705/14.27

(57) ABSTRACT

A system and method for management of electronic wallet databases is provided. In one embodiment portable electronic devices are deployed having a universal wallet application and a wallet data file associated with the application. The wallet data file is configured to maintain a plurality of different types of wallet artifacts in the form of data records. Dynamic content in association with each data record can be generated as each data record is accessed.

### FIELD

The present specification relates generally to computing and more specifically relates to a system and method for management of electronic wallet databases.

### BACKGROUND

The use of the technical features of electronic devices to replace other technologies is, of course, only increasing. Word processing software has replaced typewriters; packet switched telephony is replacing circuit switched telephony; electronic trading is replacing the traditional stock exchange; banking is also increasingly being handled by electronic transfer of funds in place of paper money or bills of exchange. But there is much more to be done.

Electronic wallet databases are extremely useful in providing a central and computerized storage, retrieval and editing environment for personal contacts. Electronic computing devices, both portable and desktop, often include contact management applications. However, further advances are possible.

### BRIEF DESCRIPTION OF THE DRAWINGS

FIG. 1 shows a system for management of electronic wallet databases.

FIG. 2 shows a schematic representation of the portable computing device of FIG. 1.

FIG. 3 shows exemplary syntax for a business card uniform resource identifier.

FIG. 4 shows exemplary screen shots from the electronic device of FIG. 1.

FIG. 5 shows exemplary screen shots from the electronic device of FIG. 1.

FIG. 6 shows exemplary screen shots from the electronic device of FIG. 1.

FIG. 7 shows exemplary screen shots from the electronic device of FIG. 1.

FIG. 8 shows exemplary screen shots from the electronic device of FIG. 1.

FIG. 9 shows a flowchart depicting a method of transferring an electronic artifact using the system of FIG. 1.

FIG. 10 shows a flowchart depicting another method of transferring an electronic artefact.

FIG. 11 shows another system for management of electronic wallet databases.

FIG. 12 shows a flowchart depicting a method of transferring electronic artifact content using the system of FIG. 11.

FIG. 13 shows an exemplary screen shot from an electronic device of FIG. 11.

FIG. 14 shows exemplary screen shots from an electronic device of FIG. 11.

FIG. 15 shows an exemplary screen shot from an electronic device of FIG. 11.

FIG. 16 shows a flowchart depicting a method of updating dynamic content using the system of FIG. 11, and where such dynamic content can be utilized by the method of FIG. 12.

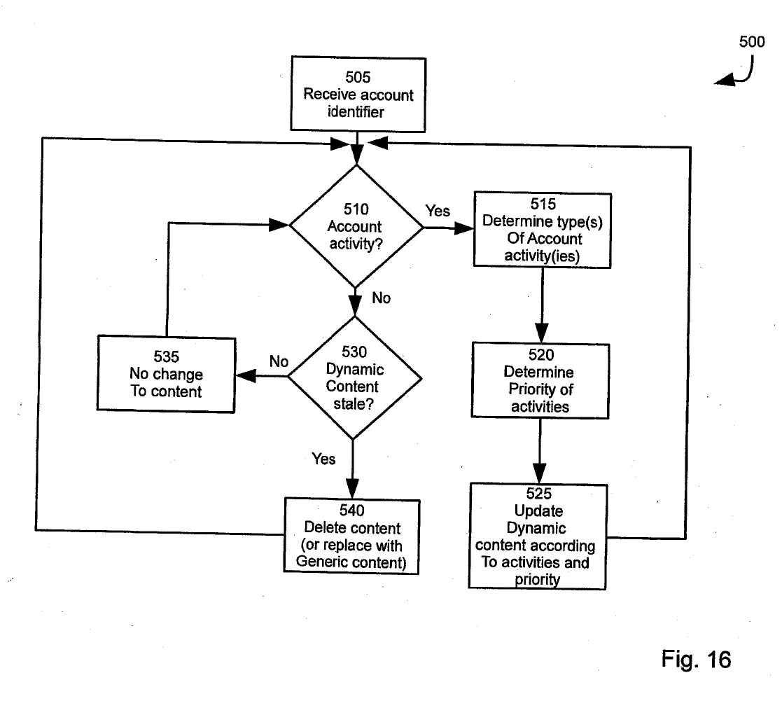

FIG. 17 shows an exemplary screen shot from an electronic device of FIG. 11.

FIG. 18 shows an exemplary screen shot from an electronic device of FIG. 11.

FIG. 19 shows an exemplary screen shot from an electronic device of FIG. 11.

### DESCRIPTION

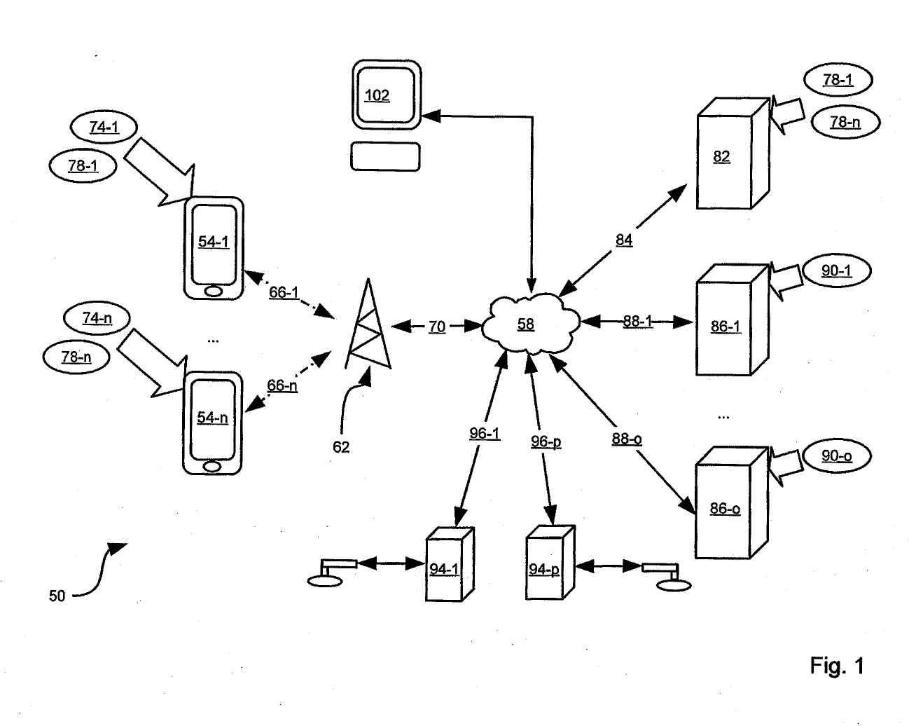

Referring now to FIG. 1, a system for management of electronic wallet databases is indicated generally at 50. In a present embodiment system 50 comprises a plurality of portable computing devices 54-1 . . . 54-n (generically, computing device 54, and collectively, computing devices 54) connected to a network 58 via a wireless base station 62. In turn, wireless base station 62 connects to portable computing device 54 via a wireless link 66 and to network 58 via a backhaul 70.

Network 58 can comprise the Internet, or can comprise any other wide area network such as the public switched telephone network (PSTN), or can comprise combinations of various network topographies.

Base station 62 can be based on one or more architectures including, without limitation, Global System for Mobile communications (GSM), General Packet Radio Service (GPRS), Enhanced Data Rates for GSM Evolution (EDGE), 3G, 4G, Universal Mobile Telecommunications System (UMTS), Institute of Electrical and Electronics Engineers (IEEE) Standard 802.11, IEEE 802.15, Bluetooth. Link 66 therefore corresponds to the architecture of base station 62, and thus portable computing device 54 includes a radio (shown below) so that it is configured to communicate via link 66. Portable computing device 54 can be configured to have multiple radios so that it can communicate over different architectures.

As will be discussed in greater detail below, each portable computing device 54 is configured to maintain its own universal wallet application 74 and a universal wallet data file 78.

System 50 also comprises at least one central server 82 which connects to network 58 via a backhaul link 84. As will be discussed in greater detail below, central server 82 and is configured to create, update, delete and otherwise maintain each universal wallet data file 78 respective to each device 54, as will be discussed in greater detail below.

System 50 also comprises a plurality of issuer servers 86-1, 86-o (generically, issuer server 86 and collectively, issuer servers 86), which are connected to network 58 via backhauls 88. As will be discussed in greater detail below, each issuer server 86 is configured to create, update, delete and otherwise maintain individual records 90 which are aggregated into data file 78 by central server 82. Each issuer server 86 is also configured to create, update, delete and otherwise maintain individual records 90 which are aggregated into data file 78 by central server 82.

System 50 also comprises a plurality of reader servers 94-1, 94-p which are connected to network 58 via backhauls 96. Each reader server 94 includes a proximity reader 98 which is an input device that is configured to read output generated by device 54 when device 54 is positioned proximal to one of the readers 98. In a present embodiment, each proximity reader 98 is a barcode scanner, but other types of proximity readers are contemplated as discussed further below.

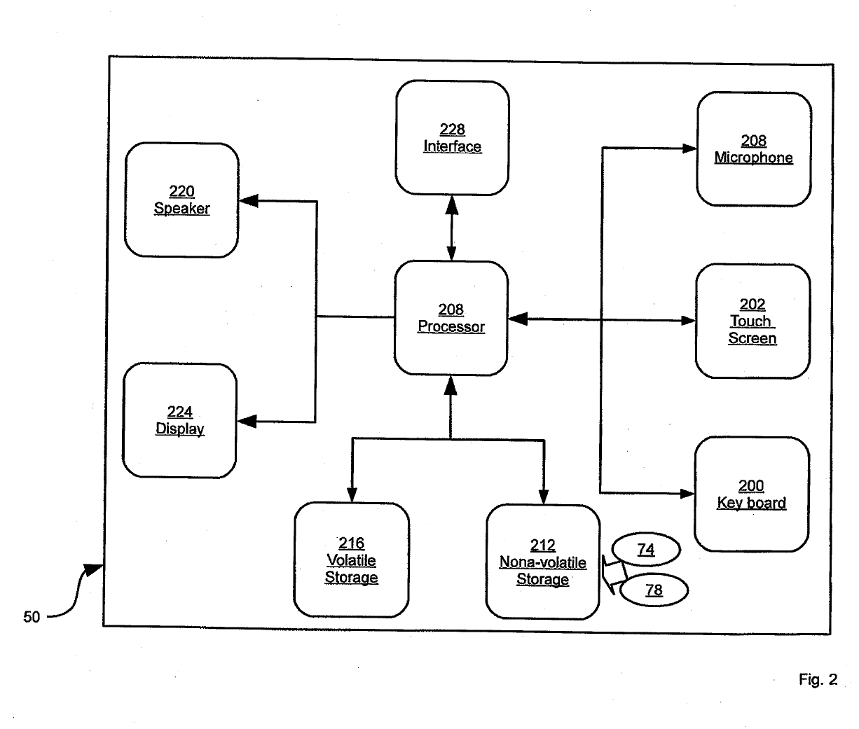

Referring briefly now to FIG. 2, each computing device 54 can be any type of electronic device that can be used in a self-contained manner and to interact with over network 58. Interaction includes displaying of information on computing device 54 as well as to receive input at computing device 54 that can in turn be sent back over network 58. It should be emphasized that the structure in FIG. 2 is purely exemplary, and contemplates a device that can be used for both wireless voice (e.g. telephony) and wireless data (e.g. email, web browsing, text) communications. In a present embodiment, computing device 54 is a mobile electronic device with the combined functionality of a personal digital assistant, a cell phone, and an email paging device. Many well known cellular telephone models, or variants thereof, are suitable for the present embodiment.

Device 54 thus includes a plurality of input devices which in a present; embodiment include a keyboard 200, a touch screen 202, and a microphone 204. Touch screen 202 can be implemented as another form of pointing device. Input from keyboard 200, touch screen 202 and microphone 204 is received at processor 208 (which can be implemented as a plurality of processors). Processor 208 is configured to communicate with a non-volatile storage unit 212 (e.g. Erasable Electronic Programmable Read Only Memory (“EEPROM”), Flash Memory) and a volatile storage unit 216 (e.g. random access memory (“RAM”)). Programming instructions that implement the functional teachings of device 54 as described herein are typically maintained, persistently, in non-volatile storage unit 212 and used by processor 208 which makes appropriate utilization of volatile storage 216 during the execution of such programming instructions. Those skilled in the art will now recognize that non-volatile storage unit 212 and volatile storage 216 are examples of computer readable media that can store programming instructions executable on processor 208.

Processor 208 in turn is also configured to control a speaker 220 and a display 224. Processor 208 also connects to a network interface 228, which are implemented in a present embodiment as radios configured to communicate over link 66. In general, it will be understood that interface 228 is configured to correspond with the network architecture that is used to implement link 66. (In other embodiments a plurality of links 66 with different protocols can be employed and thus a plurality of interfaces can be provided to support each link.) It should be understood that in general a wide variety of configurations for device 54 are contemplated.

In a present embodiment, device 54 is also configured to maintain a universal wallet application 74 and a universal wallet data file 78. Universal wallet application 74 is maintained within non-volatile storage 212. Processor 208 is configured to execute universal wallet application 74, such that when universal wallet application 74 is loaded on processor 208, various transistors and other components in processor 208 are arranged in a particular way so that device 54 is, at least temporarily, a uniquely configured piece of hardware that performs the functions of universal wallet application 74. During such time, device 54 is configured to receive input from keyboard 200 relative to universal wallet application 74, and to generate graphical interfaces on display 224. Processor 208 is further configured to access universal wallet data file 78 on behalf of universal wallet application 74, as will be discussed further below.

Referring again to FIG. 1, servers 82, 86 and 94 can be based on any well-known server environment including a module that houses one or more central processing units, volatile memory (e.g. random access memory), persistent memory (e.g. hard disk devices) and network interfaces to allow those servers to communicate over relevant links. For example, servers 82, 86, or 94 or all of them can be a Sun Fire V480 running a UNIX operating system, from Sun Microsystems, Inc. of Palo Alto Calif., and having four central processing units each operating at about nine-hundred megahertz and having about sixteen gigabytes of random access memory. However, it is to be emphasized that this particular server is merely exemplary, and a vast array of other types of computing environments for servers 82, 86, or 94 are contemplated. Those skilled in the art will now recognize that non-volatile storage and volatile storage are examples of computer readable media that can store programming instructions executable on the processors of each server.

In a present embodiment, system 50 utilizes novel custom uniform resource identifiers (“URI”) schemes to pass various forms of data, and/or references to that data, respective to each record 90. Universal wallet application 74 identifies and registers custom URI schemes for each record 90 that conform to the Internet standard described in public RFC 3986—“Uniform Resource Identifier (URI): Generic Syntax”, which may be referenced here: http://labs.apache.orq/webarch/uri/rfc/rfc3986.html. (“URI Standard”)

Each type of record 90 that wallet application 74 handles is identified by a custom URI scheme. In accordance with the URI Standard, wallet application 74 defines each scheme identifier as well as each constituent component of the URI—the “authority”, “path”, “query”, and “fragment” components. The nature and contents of this latter set of components varies depending upon the specific attributes of the particular type of record 90 that is being described.

Operationally, when one of the URIs associated with a record 90 is encountered during routine user interaction with applications on the mobile device, wallet application 74 is launched and passed the custom URI data associated with a record 90. Such an event triggers the appropriate business process execution within the application 74, based on the specific scheme and data components described in the incoming URI.

A present embodiment comprises a set of custom URIs using the approach outlined above, however further new URIs to this list over time to support other types of records 90. Table I provides such an exemplary list of custom URI schemes:

TABLE I

| URI Scheme | |
|---|---|
| Definition | Type of Record 90 |
| “Bizcard://” | A virtual business card or contact data |
| “VanityCard://” | A user-created representation of a plastic or paper |
| | ID card |
| “LoyaltyCard://” | A store-issued customer card |
| “IDCard://” | A card used mainly for identification purposes, such |
| | as a student ID |
| “SVCard://” | A representation of a stored value card (i.e. gift or |
| | prepaid card) |
| “RetailCoupon://” | A coupon issued by a retailer or store |
| “MfgCoupon://” | A coupon issued by a product manufacturer |
| “EventBadge://” | A credential issued to permit access to an event |
| “Receipt://” | A digital representation of a sale receipt |
| “EventTicket://” | A ticket to a short-duration event such as a concert |
| | or game |
| “SubscriberPass://” | A recurring, longer duration pass such as for public |
| | transit systems |
| “Calendar://” | A virtual calendar appointment or event |

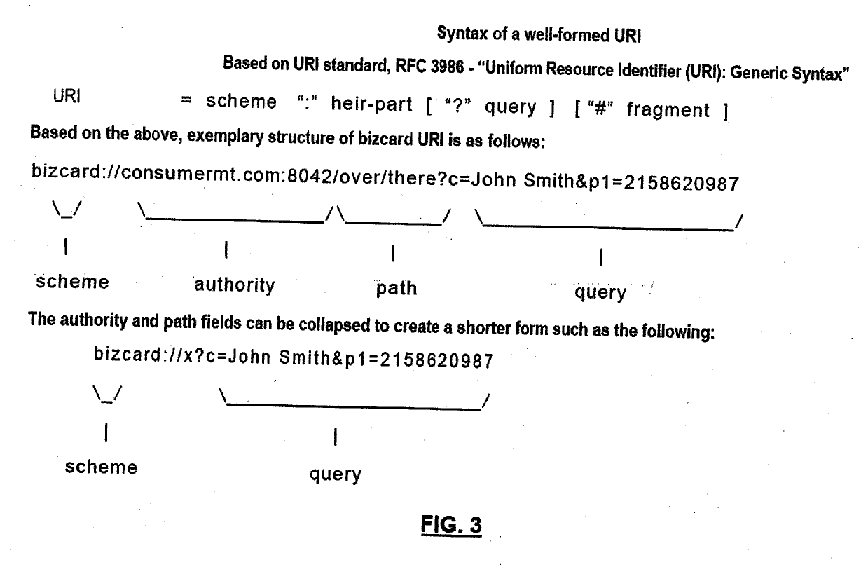

FIG. 3 shows an exemplary structure for the “Bizcard://” URI Scheme Definition. As the example in FIG. 3 shows, the various fields that make up the business card contents are encoded within the query string of the URI. Note that several of the fields are optional and can be left out if desired. In addition, more fields may be added to the definition in the future as needs dictate. Table II summarizes exemplary field identifiers that can be supported for the “Bizcard://” URI Scheme.

TABLE II
Exemplary Bizcard URI Scheme Fields

| Field | Prefix |
|---|---|
| Full name or composite name | c= |
| First name | f= |
| Last name | l= |
| Organization | o= |
| Title | j= |
| Email address | e= |
| Street address 1 | r1= |
| Street address 2 | r2= |
| City | t= |
| State/province | s= |
| Postal code | z= |
| County | y= |
| URL | u= |
| Phone 1 | p1= |
| Phone 2 | p2= |
| Note | n= |

Using Table II, an exemplary business card URI can appear as follows (ignoring the carriage returns resulting of page width restrictions):

“bizcard://v?c=John R. Smith&f=John&I=Smith&o=Tyco Toys Inc.&=President and CEO&e=john.smith@tyco.com&r1=123 Main St.&2=Suite 101&t=Newtown&s=PA&z=18935&y=USA&u=www.tyco.com&p1=2158452340&p2=2 673439087&n=We are tops in toys”. Those skilled in the art will now appreciate that the other URI schemes from Table I can be constructed in a like fashion.

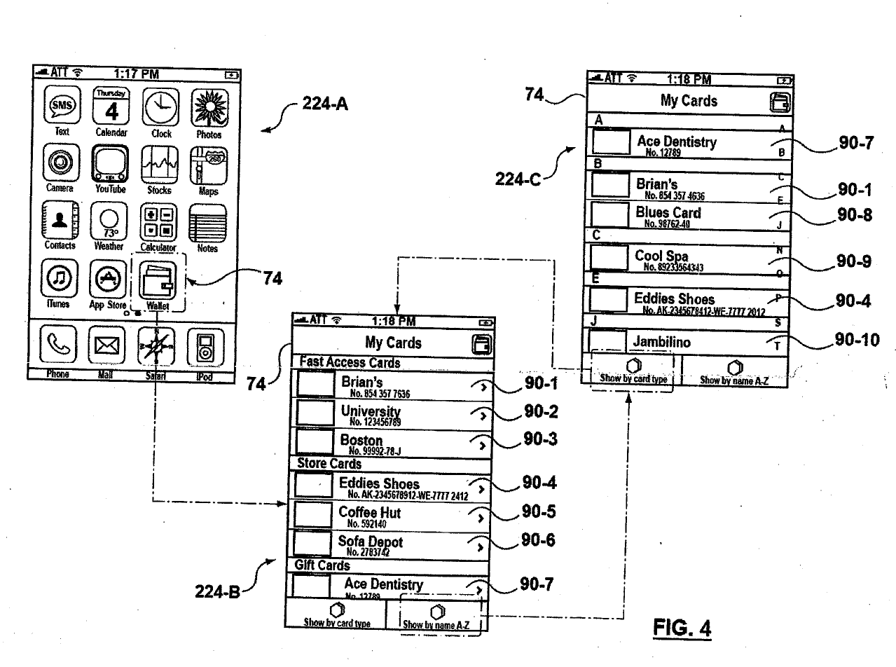

Referring now to FIG. 4, exemplary screen shots from display 224 of device 54 are provided showing certain exemplary invocation and performance of application 74. The first screen shot, marked as display 224-A shows the main menu of a plurality of applications which can be executed on device 54, including wallet application 54. Upon depressing touchscreen 202 in the area of display 224-A corresponding to the icon for application 74, application 74 will be loaded onto processor 208 and executed thereby. Upon loading and execution of application 74 onto processor 208, the screen shot marked as display 224-B on FIG. 4 shows a screen labeled “My Cards” which includes a plurality of virtual cards of various types, each of those cards representing a different data record 90. On display 224-B, cards are sorted by type. Depressing touchscreen 202 in the area of display 224-B indicated will invoke display 224-C, which sorts the same cards alphabetically. Note that display 224-B and display 224-C contemplate ten different cards corresponding to ten different data records 90. It is to be understood that any number of different cards and corresponding data records 90 can be maintained in device 54 subject to resource (i.e. memory and processor) constraints of device 54. Note that cards corresponding to data records 90 on display 224-B and display 224-C thus reflect the contents of universal wallet data file 78. Also note that while ten different cards are shown in display 224-B and display 224-C, only two card issuer data servers 86 are shown in FIG. 1, but it should be understood that more card issuer data servers 86 can be provided, one for each card corresponding to each data record 90. Device 54 is configured to return from display 224-C to display 224-B when the area of display 224-C that is indicated is depressed.

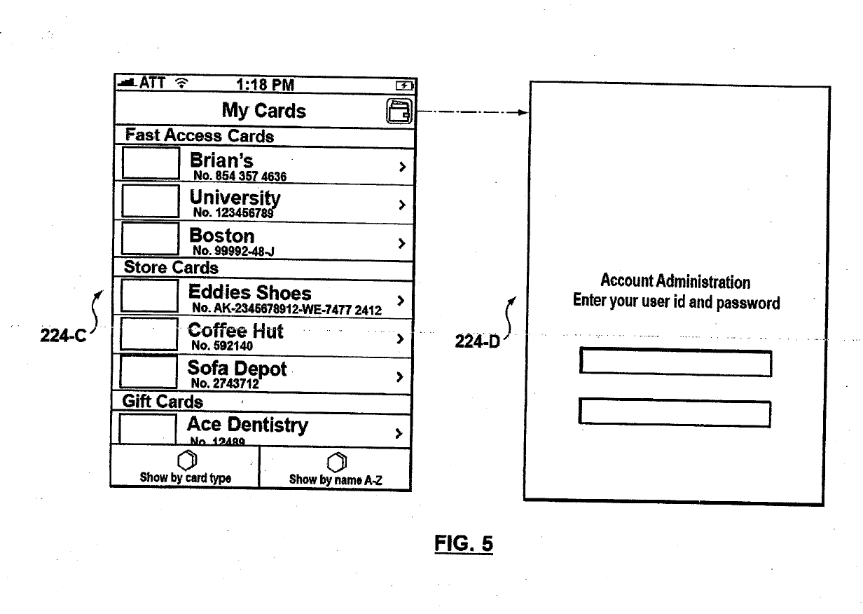

Referring now to FIG. 5, depressing touchscreen 202 in the indicated area of display 224-C will invoke display 224-D. Display 224-D shows a log-in screen for an administration tool that is hosted by central server 82 which can be used to administer the account on central server 82 that corresponds to device 54 and data file 78. Display 224-D and such account administration can also be invoked from the web-browser computer 102. Such administration can include updating identity information, address information, data records 90 and other administrative operations

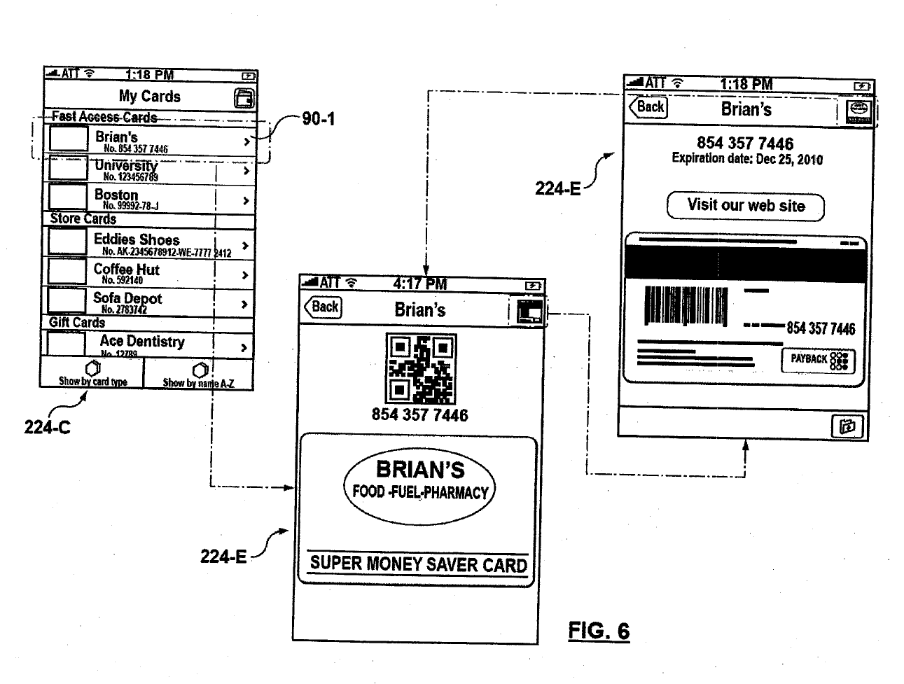

Referring now to FIG. 6, depressing touchscreen 202 in the indicated area of display 224-C will invoke display 224-E. Depressing touchscreen 202 in the indicated area of display 224-E will invoke display 224-F. Display 224-E and display 224-F show the contents of data record 90-1 corresponding to a first card. Data record 90-1 is of the URI Scheme Definition “LoyaltyCard://” In the present embodiment display 224-E shows the front of a virtual loyalty card issued by a pharmacy, whereas display 224-F shows the back of the same virtual loyalty card. Note that in the present embodiment the front and back of the virtual loyalty card is substantially an accurate facsimile of an actual loyalty card that is typically carried in a physical wallet.

Display 224-E, in addition to showing the front of the virtual loyalty card, also includes a machine readable indicia that can be read by reader 98.

Display 224-F, as part of the back of the virtual loyalty card, includes a facsimile of a bar code that would actually appear on the back of the virtual loyalty card, such a bar code being an additional machine readable indicia that can be read by reader 98. In addition to the back of the virtual loyalty card, display 224-F also includes a reproduction of the loyalty card number, the expiry date and a selectable area of touchscreen 202 entitled “Visit our web site” that can be selected to cause display 224 to shows a web-site hosted on the issuer server 86-1 corresponding to data record 90-1, such a web-site allowing administration of an individual account associated with data record 90-1.

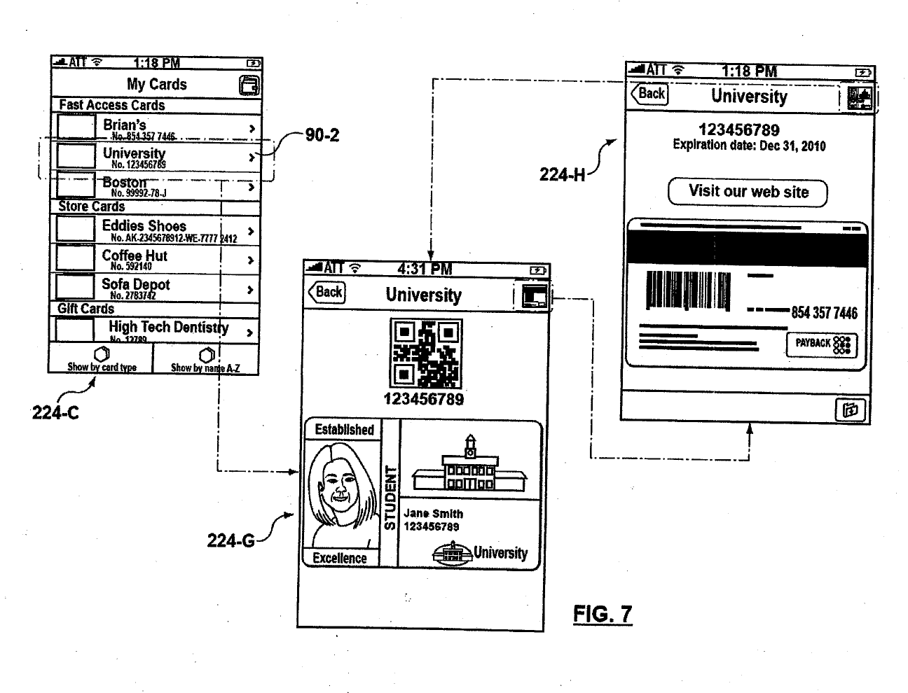

Referring now to FIG. 7, depressing touchscreen 202 in the indicated area of display 224-C will invoke display 224-G. (Note that this area in FIG. 7 is slightly different than the corresponding area in FIG. 5. This is for example purposes only—either area can be selected.) Depressing touchscreen 202 in the indicated area of display 224-G will invoke display 224-H. (Note that this area in FIG. 7 is slightly different than the corresponding area in FIG. 5. This is for example purposes only—either area can be selected.) Display 224-G and display 224-H show the contents of data record 90-o corresponding to a second card. Data record 90-o is of the URI Scheme Definition “IDCard://” In the present embodiment display 224-E shows the front of an identity card issued by a university, whereas display 224-F shows the back of the same university identity card. Note that in the present embodiment the front and back of the university identity card is substantially an accurate facsimile of an university identity card that is typically carried in a physical wallet.

Display 224-G, in addition to showing the front of the identity card, also includes a machine readable indicia that can be read by reader 98.

Display 224-H, as part of the back of the identity card, includes a facsimile of a bar code that would actually appear on the back of the identity card, such a bar code being an additional machine readable indicia that can be read by reader 98. In addition to the back of the identity card, display 224-F also includes a reproduction of the identity card number, the expiry date and a selectable area of touchscreen 202 entitled “Visit our web site” that can be selected to cause display 224 to shows a web-site hosted on the issuer server 86-o corresponding to data record 90-o, such a web-site allowing administration of an individual account associated with data record 90-o.

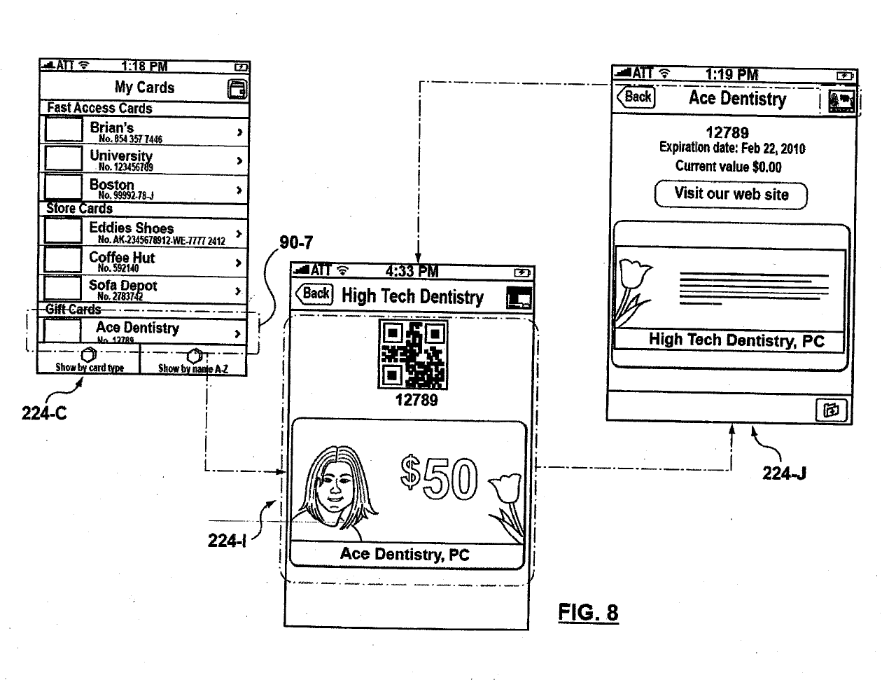

Referring now to FIG. 8, depressing touchscreen 202 in the indicated area of display 224-C will invoke display 224-I. Depressing touchscreen 202 in the indicated area of display 224-J will invoke display 224-I. Display 224-J and display 224-I show the contents of data record 90-7 corresponding to another card. Data record 90-7 is of the URI Scheme Definition “SVCard://” In the present embodiment display 224-I shows the front of a gift card issued by a dentist, whereas display 224-J shows the back of the same gift card. Note that in the present embodiment the front and back of the gift card is substantially an accurate facsimile of a gift card that is typically carried in a physical wallet.

Display 224-I, in addition to showing the front of the gift card, also includes a machine readable indicia that can be read by reader 98.

Display 224-J, as part of the back of the gift card, includes a legal disclaimers that actually appear on the back of the virtual loyalty card. In addition to the back of the gift card, display 224-J also includes a reproduction of the gift card number, the expiry date and a selectable area of touchscreen 202 entitled “Visit our web site” that can be selected to cause display 224 to shows a web-site hosted on the issuer server 86 corresponding to data record 90-7, such a web-site allowing administration of an individual account associated with data record 90-7. Display 224-J also shows the current remaining value on the gift card, shown as “Zero” on display 224-J.

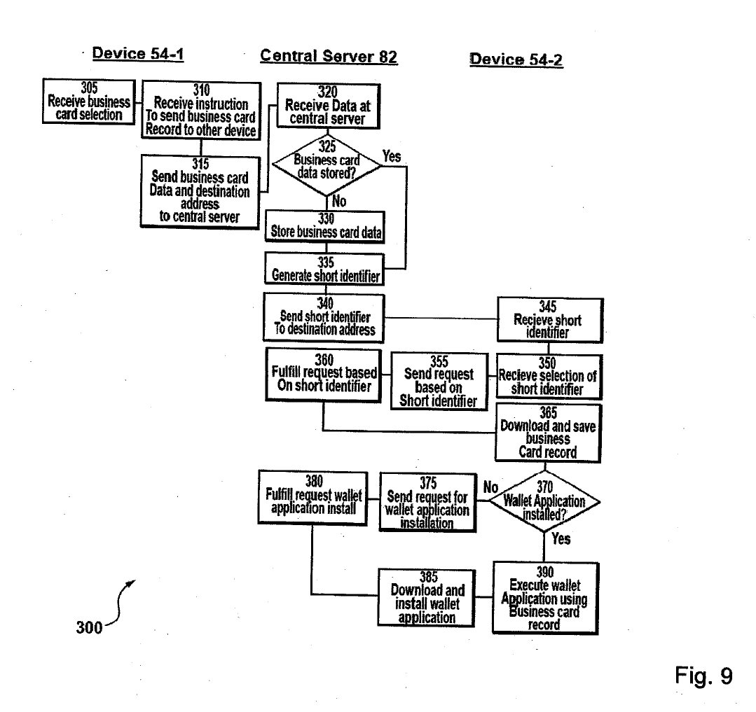

Referring now to FIG. 9, a method for transferring a business card record from one portable computing device to another portable computing device is depicting in the form of a flow-chart and indicated generally at 300. Method 300 can be explained using system 50, and in the context of device 54-1, server 78 and device 54-2 but it will be understood that method 300 can be implemented on variations of system 50. In the following description, it will be assumed that device 54-1 has a business card data record 90 stored thereon, and that business card data record 90 is to be transferred to device 54-2.

At block 305, a selection of a business card record is received. In the present example, block 305 is performed by device 54-1. Block 305 can be effected in much the same manner as gift card record 90-7 was selected accord to FIG. 8, or the other examples in FIGS. 6 and 7. Such a selection is for a business card record conforming with a business card URI scheme, such as the scheme shown in FIG. 3, as stored in data file 78 of device 54-1.

At block 310, an instruction is received to send the selected business card record to another device. Block 310 can be effected by receipt of an instruction received via a touch screen 202, which indicates that the record selected at block 305 is to be sent to another device, the address of such a destination device being also received at block 310. The destination device address can be received in any form, but a typical example is the Mobile Subscriber Integrated Services Digital Network (ISDN) Number (MSISDN) or the actual telephone number associated with the destination device. A menu item can be provided as part of wallet application 74 that is generated on display 224 can be used to simplify the ease of provision of the instruction associated with block 310. In the present example, the instruction at block 310 indicates that the record is to be sent to device 54-2.

At block 315, the business card record selected at block 310 is sent to the central server. Block 315 is effected by device 54-1 transmitting business card record 90 to central server 82 via the infrastructure in system 50 of FIG. 1, or a suitable variation thereof.

At block 320, the business card record sent at block 315 is received at server 82. At block 325, a determination is made as to whether the business card record received at block 320 is already stored at central server 82 in the copy of data file 78 that is maintained at central server 82. If “no”, then method 300 advances to block 330 and the business card record received at block 320 is stored in data file 78. If the determination at block 325 is “yes” then method 300 advances to directly block 335.

At block 335, a short identifier is generated. Such a short identifier is uniquely associated with the business card record received at block 320 and stored in the copy of data file 78 that is local to server 82. The short identifier can be in the form of a hyper text transfer protocol (HTTP) URI, of the exemplary form, “http:/centralserver82.com/businesscardrecord90”. In the foregoing example, “centralserver82.com” represents the uniform resource locator (URL) for central server 82 on network 58, while “businesscardrecord90” identifies the business card record received at block 320 and stored at the copy of data file 78 that is locally maintained on central server 82.

At block 340, the short identifier generated at block 335 is sent to the destination device that was originally identified at block 310, such a destination address having been transmitted to server 82 at block 315. In a present embodiment, the short identifier is sent via short message service (SMS). In this manner, central server 82 need not have any understanding of the architecture or computing environment of the destination device 54-2. Thus, the composed SMS can include the following exemplary text: “You are being sent an electronic business card record. To retrieve this record, please select the following link from your mobile device browser: http:/centralserver82.com/businesscardrecord90”. The SMS is sent via the infrastructure in FIG. 1, or a suitable variation thereof. The text as you quote it would not be a legal SMS message, as it exceeds length restrictions (160 chars max). This is why I gave the alternate sample above that a) is of a legal length, and 2) includes the link by which the app can be loaded (that you explain later on below).

At block 345, the short identifier is received at the destination device 54-2. In the present embodiment, the SMS described at block 340 is received via an SMS application local to device 54-2.

At block 350, a selection of the short identifier is received. Block 350 typically comprises execution of the SMS application local to device 54-2 and generation of the SMS on display 224 of device 54-2. Block 350 further comprises the selection of the short identifier (i.e. http:/centralserver82.com/businesscardrecord90) via input entered through touch screen 202 or other pointing or input device on device 54-2, so as to invoke a browser application local to device 54-2 on the processor 208 of device 54-2. (In the event such a selection is not made, then method 300 terminates).

At block 355, a request is sent to the central server based on the short identifier selected at block 350. In the present example, the request is sent using the browser application native to device 54-2 via the infrastructure of FIG. 1 or a suitable variation.

At block 360, the request from block 355 is received at server 82 and fulfilled. In the present example, block 360 is effected by server 82 accessing the local copy of data file 78 to retrieve the business card record 90 received at block 320 and to send that business card record 90 to device 54-2. At block 365 the business card record sent at block 360 is downloaded and saved in a local copy of data file 78 at device 54-2. In the present example, the business card record 90 is sent in the form described above, namely in the form as follows:

“bizcard://v?c=John R. Smith&f=John&I=Smith&o=Tyco Toys Inc.&j=President and CEO&e=john.smith@tyco.com&r1=123 Main St.&r2=Suite 101&t=Newtown&s=PA&z=18935&y=USA&u=www.tyco.com&p1=2158452340&p2=267343 9087&n=We are tops in toys”.

At block 370 a determination is made as to whether the wallet application is installed. If the determination is “no” then at block 375 a request is sent to download and install the wallet application 74 locally on device 54-2. At block 380 the request from block 375 is received and fulfilled at server 82 by sending a file that can be used to install application 74 on device 54-2. At block 385 the wallet application is downloaded onto device 54-2 and installed locally thereon. At block 390 (which can be reached directly from block 370 if a “yes” determination is made at block 370), the wallet application is executed using the business card record downloaded at block 365. At this point device 54-2 is able to generate screens in the type shown in FIGS. 4-8.

(As variation of method 300, and an alternative to an automatic determination at block 370, method 300 can be varied to eliminate block 370 such that it is presumed that wallet application is already installed, or providing an alternative flow so that user input can be received requesting download and installation of the wallet application). Graphical images associated with the downloaded card are downloaded separately, such that when input is received to access a particular card in the wallet application, then a web service call is made dynamically (right now to a free Google web service) to get the generated image associated accessed business card.

It should be understood that each device 54 can be manufactured by different entities and can have varying infrastructures, in which case the exact structure of application 74 and file 78 for each device 54 can vary according to those infrastructures. Therefore, it will be noted that the fulfilling of the download request at block 380 can include sending the version of application 74 that is configured specifically to the unique infrastructure of the device 54 requesting download and installation of that application.

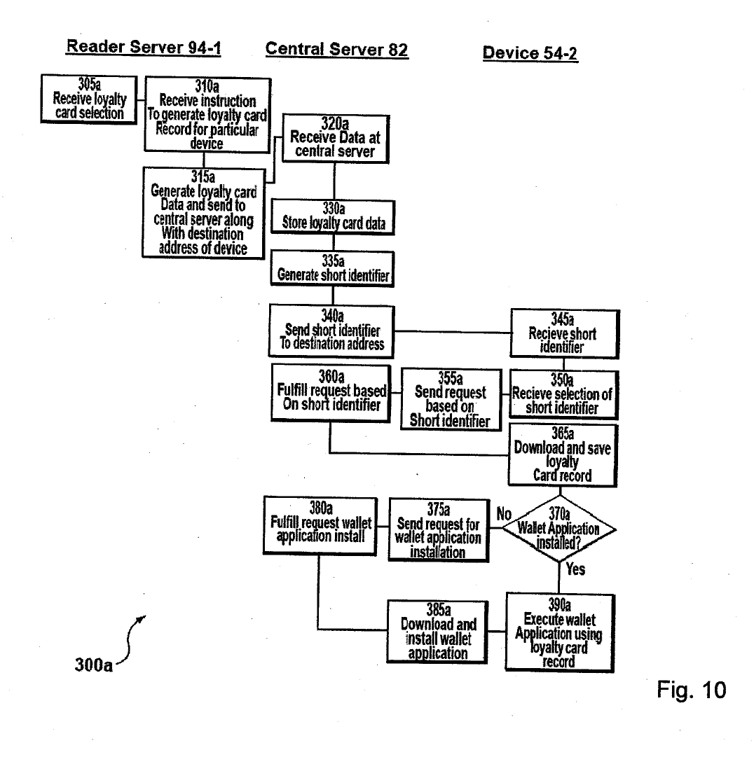

Those skilled in the art will now recognize that method 300 can be varied in order to send other types of data records 90 to devices 54. FIG. 10 shows such an example of a variation of method 300, in the form of method 300a. In method 300a, like blocks to method 300 are shown with the same reference, except followed by the suffix “a”. Of note is that method 300a pertains to the generation and sending of a loyalty card data record 90 to a device 54, and thus method 300a arises in the context of generation of a loyalty card. In method 300a, it is assumed that reader server 94-1 is associated with a point of sale of an enterprise that utilizes loyalty cards, and that device 54-2 is proximal to that reader server 94-1 but that device 54-2 has no loyalty card record associated with that enterprise, but that a request is being made to generate such a loyalty card record 90 so that such a loyalty card record can be generated and stored locally on device 54-2. It is also assumed that issuer server 86-1 is associated with the enterprise and is configured to generated loyalty card records 90 respective to that enterprise.

In the specific example of FIG. 10, method 300a, blocks 305a and 310a involve receiving a request to generate loyalty card record 90-1 at reader server 94-1 which is sent to issuer server 86-1. Block 305a can include all particulars that are needed to generate the loyalty card record, including destination MSISDN, a name and/or address to be included in the loyalty card record and the like.

At block 315a, issuer server 86-1 receives the request generated at block 310a and in response generates loyalty card record 90-1 and forwards that data to central server 82a. The generation of the loyalty card record 90-1 can include incorporation of the particulars received at block 305a, as well as a specific loyalty card number for that record 90.

At block 315a, the loyalty card data and the destination MSISDN is sent to the central server 82, where it is received at block 320a. At block 330a the loyalty card data is stored in the central server local version of data file 78. The remainder of method 300a is effected in substantially the same manner as the corresponding blocks in method 300. Advantageously, the entire performance of method 300a can be performed within minutes, or even less than a minute, such that when block 390a is reached the loyalty card record 90 can be generated on display 224, in much the same manner as shown in FIG. 6, such that the reader 98-1 can be used to read the machine readable indicia from record 90 as discussed above.

Those skilled in the art will now appreciate that other URI scheme definitions from Table I can also be deployed using suitable modifications of method 300 or method 300a.

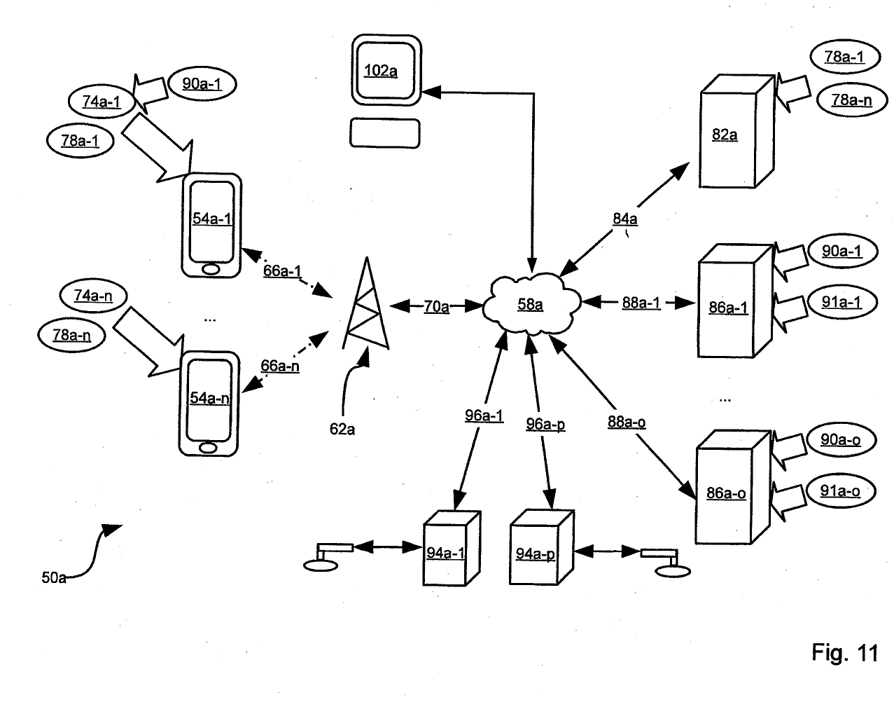

Referring now to FIG. 11, according to another embodiment a system for management of electronic wallet databases is indicated generally at 50a. System 50a is a variation on system 50, and accordingly, like elements bear like references, except the suffix “a” is included for elements in system 50a. Of note is that in system 50a, servers 86a further comprise at least one dynamic content file 91a. Dynamic content file 91a, in general terms, comprises data that is dynamically updated in relation to a corresponding data record 90a. As will be explained further below, a display can be generated on a given device 54a that comprises both a given record 90a maintained with a local data file 78a, as well as a corresponding dynamic content file 91a.

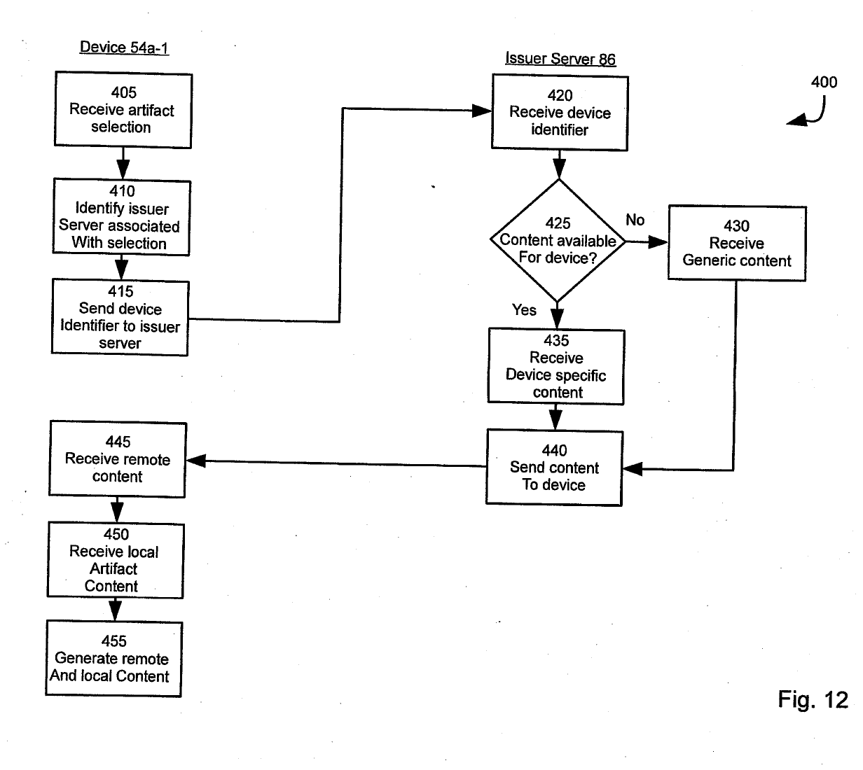

Referring now to FIG. 12, a method for management of electronic wallet databases is depicted in the form of a flow-chart and indicated generally at 400. Method 400 can be explained using system 50a, and in the context of device 54a-1, server 82a and server 86a, but it will be understood that method 400 can be implemented on variations of system 50a. In the following description, it will be assumed that device 54a-1 has an airline reward miles card data record 90a-1 stored thereon which was transferred thereto according to one of the earlier described teachings, or a variation thereon. It will be further assumed that airline reward miles card data record 90a-1 was issued by server 86a-1.

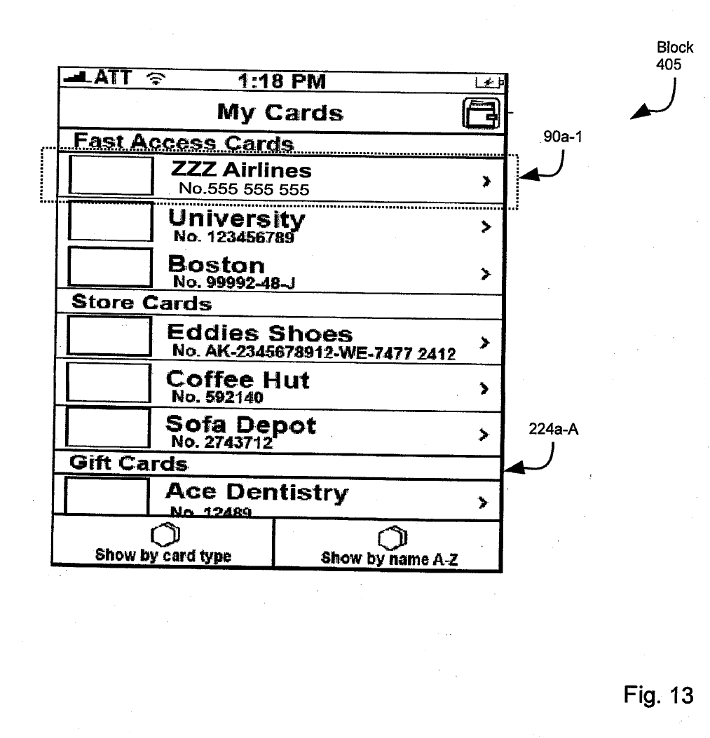

Beginning at block 405, an artifact selection is received. For purposes of explaining the block 405, reference is made to FIG. 13, which shows exemplary selection of record 90a-1 from an exemplary display 224a-A. Note that record 90a-1 corresponds to an airline reward miles card entitled “ZZZ Airlines” with the account number “555 555 555”. Again, as previously discussed, record 90a-1 was originally issued by issuer server 86a-1, which is assumed to be operated by an airline named “ZZZ Airlines”, and which has issued a reward miles card for storage on a given device 54a.

Referring again to FIG. 12, block 410 comprises identifying an issuer server associated with the selection received at block 405. In the present example, record 90a-1 is configured to maintain a network address (such as an Internet Protocol address) or other identifier of server 86a-1 which can be used to address server 86a-1 via network 58a. Accordingly, as part of block 410, and in response to the selection made at block 405, an examination of record 90a-1 is made to ascertain the address associated with record 90a-1.

Block 415 comprises sending the device identifier, or other account identifier associated with record 90a-1, to the issuer server identified at block 415. The device identifier or account identifier can be based on, for example, the account number “555 555 555” that is associated with record 90a-1. Other device identifiers or account identifiers will now occur to those skilled in the art, including, by way of non-limiting example, the phone number associated with device 54a-1, or International Mobile Subscriber Identity (IMSI) associated with device 54a-1. It is also contemplated that multiple identifiers may be sent at block 415 in order to assist in authentication of a valid request.

Block 420 comprises receiving the device identifier at the issuer server identified at block 410. At this point it will now be apparent that block 420 (and following steps) are performed by whichever issuer server 86a that is identified at block 410. Continuing with the specific example discussed above, issuer server 86a-1 will receive the account number “555 555 555” at block 420. Implicit with receipt of this account number is a recognition at server 86a-1 that an artifact selection corresponding to record 90a-1 was made at block 405, and that an instruction has been received at processor 208 to control display 224 to generate the contents of record 90a-1.

Block 425 comprises determining if content is available for the device corresponding to the device identifier received at block 420. A “no” determination leads to block 430, at which point generic content is retrieved. Generic content may comprise no data whatsoever, or may comprise general messages that can be addressed to any holder of (in the specific example being discussed) an airline reward miles card issued by server 86a-1. Such general messages, in the context of the airline, can include, for example, messages identifying upcoming seat sales for the airline.

In contrast, a “yes” determination at block 425 leads to block 435. Block 435 comprises receiving device specific content, which may be content targeted for a particular device. Device specific content comprises messages that are specifically associated with the device or account identifier received at block 420. As a non-limiting example, an accumulated “air miles” balance associated with account number “555 555 555” may be retrieved from storage on, or accessible to, server 86a-1. In particular, such an accumulated “air miles” balance may be stored in dynamic content file 91a.

Assume, for purposes of explanation, that a balance of “27000 miles” is accumulated in association with account number “555 555 555” and is stored within dynamic content file 91a-1.

Block 440 comprises sending content that was received either at block 435, or at block 430, to the device. More specifically, the content is sent to the device associated with the device identifier received at block 420. In the specific example being discussed, the dynamic content from block 435 is sent at block 440, such dynamic content comprising “Your current balance is 27000 miles”.

Block 445 comprises receiving remote artifact content. Block 445 thus comprises receiving the content 91a-1 (e.g. “Your current balance is 27000 miles”.) that was sent at block 440 locally at device 54a-1.

Block 450 comprises receiving local artifact content. Block 450 thus comprises receiving the contents of record 90a-1 as locally stored on device 54a-1.

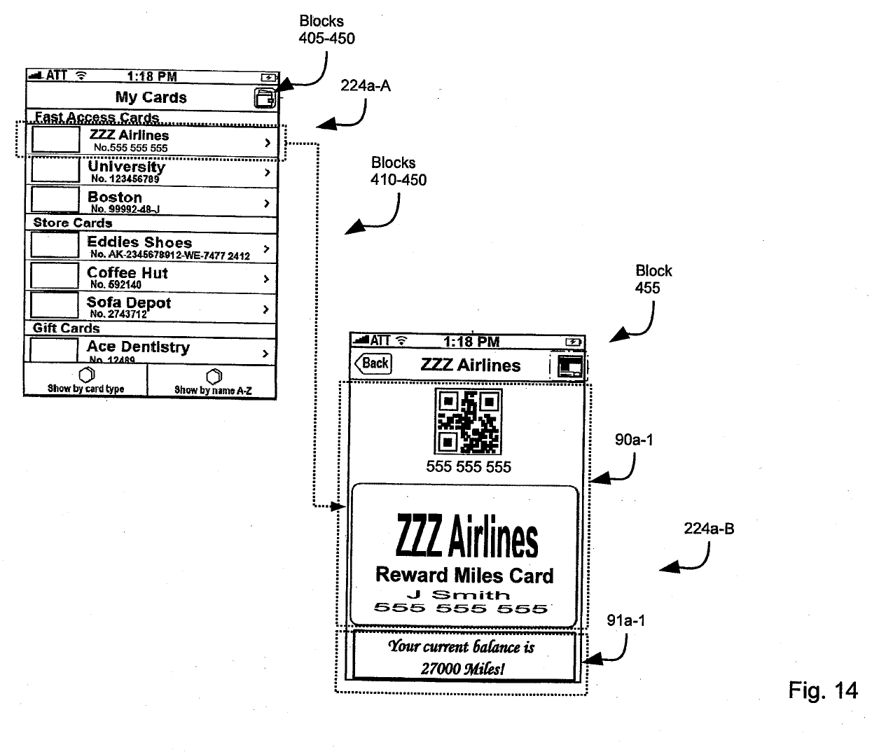

Block 455 comprises controlling the display of the device to generate the content received at block 445 and block 450. Block 455 is represented, in a non-limiting exemplary manner, in FIG. 14, which shows exemplary generation of record 90a-1 and content 91a-1 on display 224a-B, under the control of processor 208. Note that display 224a-B shows record 90a-1, and also shows content 91a-1. It should be understood that the layout of display 224a-B as shown in FIG. 14 is purely exemplary, and that other layouts are contemplated. For example, content 91a-1 may be shown between different portions of record 90a-1, such as between the bar code representation of the wallet artifact, and the graphic representation of the wallet artifact.

It should be noted that method 400 can be modified so that the portion of display 224a-B reserved for content 91a-1 can be left blank in the event that a period of time between block 415 and block 445 is exceeded, without actually receiving the remote content at block 445. Furthermore, when link 66a-1 is “off”, so that there is no communication between device 54a-1 and base station 62a, then method 400 can be modified to omit blocks 415 through 445.

It should also be understood that the blocks in method 400 need not be performed in the sequence shown. For example, block 450 can be performed at almost any time after block 405 and prior to block 455.

As another variation, one or more of blocks 420, 425, 430, 435 and 440 can be performed by central server 82 instead of issuer server 86.

As another variation, one or more communications in method 400 between a given server and a given device may be conducted over a secure, encrypted channel to preserve confidentiality and privacy.

As another variation, method 400 can be modified to reflect a “push” paradigm. Such a push paradigm can be effected by, for example, making block 420-440 non-contingent on performance of blocks 405-415.

Any or all variations contemplated herein may be combined with each other.

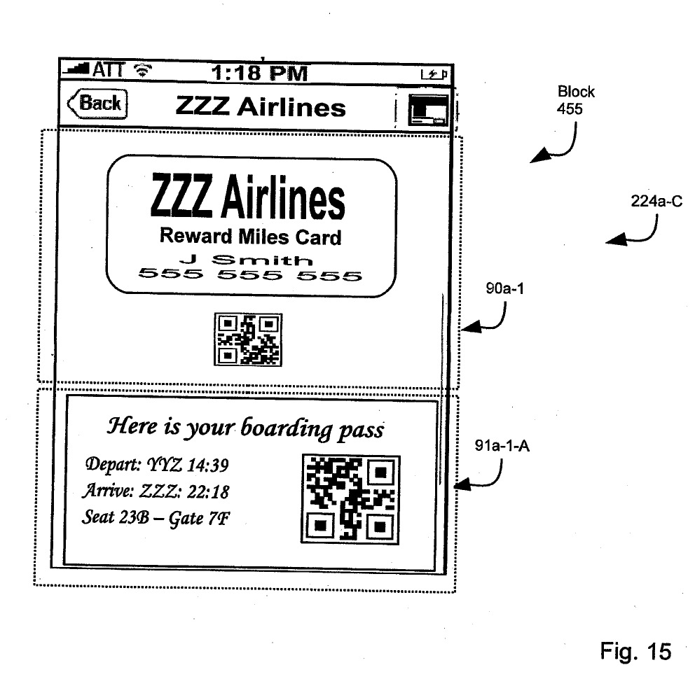

It should also be understood that content 91a-1 can comprise additional content, or different content, than in the specific example shown in FIG. 14. FIG. 15 shows such an example, which shows exemplary performance of block 455, except that content 91a-1 is replaced with content 91a-1-A. Content 91a-1-A, which can be retrieved from server 86a-1, is an electronic boarding pass corresponding to an upcoming flight that is associated with device 54a-1, as identified by account “555 555 555”.

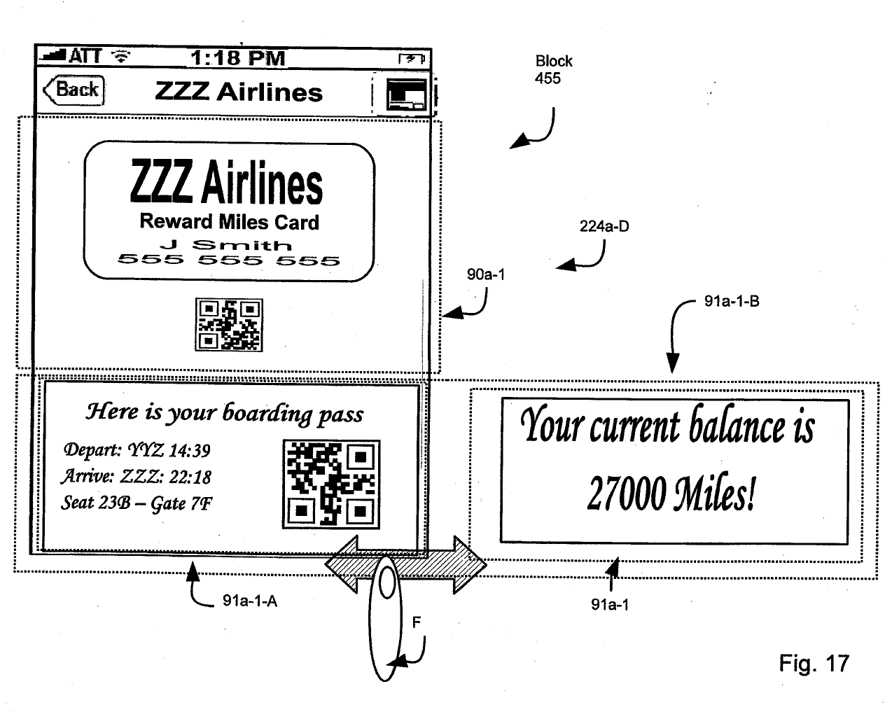

Indeed, the means by which dynamic content 91a is updated is not particularly limited. However, it is, in fact, contemplated that during subsequent cyclings of method 400, the content sent at block 440 will change, even though the local artifact content from block 450 may not change. Referring now to FIG. 17, a non-limiting example of a method for updating dynamic content is depicted in the form of a flow-chart and indicated generally at 500. Method 500 can be performed by issuer server 86a, or, in a modified version of system 50a, central server 82a or elsewhere.

Block 505 comprises receiving an account identifier or other device identifier. The account or device identifier can be any identifier that uniquely identifies a given artifact or record 90a. For example, in the example shown in FIG. 14, the identifier was the account number “555 555 555”. Generally, the identifier at block 505 will be the same as, or map to, the identifier referenced at block 420.

Block 510 comprises determining if there has been any account activity. The means by which the determination is made at block 510 is not particularly limited. In general terms, any change to any database that has records associated with the account identifier from block 505 can result in a “yes” determination at block 510, and in contrast, where no changes have occurred in any databases that have records associated with the account identifier from block 505 can result in a “no” determination at block 510. As a specific, non-limiting example, any scanning of a bar code within a record 90a by a reader 98a and processing of that bar code can constitute activity that results in a “yes” determination. As another example, an electronic purchase or other electronic transaction that is tracked in association with the account identifier at block 505 can result in a “yes” determination at block 510.

In the specific example given above, an electronic purchase of an airline ticket that results in the generation of the boarding pass shown in FIG. 15 can result in a “yes” determination being made at block 51. (Note that during a subsequent cycling of method 500, the generation of the boarding pass shown in FIG. 15, in and of itself, would not constitute account activity, as a “yes” determination will have been achieved once during cycling of method 500.)

To assist with explanation of method 500, assume that prior to performance of method 500, the dynamic content stored on server 86a was in the form of content 91a-1 as shown in FIG. 14. Next, assume that subsequent to generation of display 224a-B in FIG. 14, the airline ticket corresponding to the boarding pass in FIG. 15 is electronically purchased and associated with account “555 555 555”. Thus, in these assumptions, method 500 advances from block 510 to block 515.

Block 515 comprises a determination of the type of account activities. In the specific example being discussed, it is determined that the type of account activity is a purchase of an airline ticket. Note it is contemplated that a plurality of activities may have occurred, and so a plurality of determinations may be made. For example, multiple airline tickets may have been purchased—e.g. an outbound flight ticket, and a return flight ticket.

Block 520 comprises prioritizing the activities, if there have been multiple activities. In the example of multiple plane tickets, then the prioritization can be based on ranking the outbound flight as first, and the return flight as second.

Block 525 comprises updating dynamic content according to the priorities from block 520. In the airline ticket example, where there is a single airline ticket purchase, then, at block 525, content 91a-1 (as shown in FIG. 14) may be changed to content 91a-1-A (as shown in FIG. 15). At this point method 500 cycles back to block 510.

A “no” determination at block 510 leads to block 530 where a determination is made if the dynamic content is stale. The means for making a “yes” determination at block 530 are not particularly limited can comprise a simple timer where if there has been no account activity for a given time period (e.g. weeks, months, years), or there has never been account activity, then a “yes” determination is made at which point at block 540 is reached. Block 540 can comprise deleting any existing dynamic content. (e.g. if the flight associated with content 91a-1-A has already occurred then content 91a-1-A may be deleted. However, the completion of the flight may also be deemed “account activity” leading to a “yes” determination at block 510). Block 540 can also comprise populating dynamic content 91a with generic content (thereby obviating the need for the decision box at block 425 and block 430). Such a generic message can comprise, for example “Welcome to ZZZ Airlines”, or other generic message already discussed. Method 500 returns to block 510 from block 540.

A “no” determination at block 530 leads to block 535, at which point no change is made to the dynamic content and method 500 returns to block 510.

Variations on method 500 are contemplated. For example, the determination whether dynamic content is “stale” and the associated actions (i.e. blocks 530, 535 and 545) can be performed locally by device 54a. In this example, device 54a may be configured to delete dynamic content after a predefined period of time and then to substitute such deleted dynamic content with generic content.

As another example, it is contemplated that dynamic content 91a generated at block 525 can have multiple views which can be scrolled via touch screen 202 (or other input device) while content 90a-1 remains static. Accordingly, at block 525, dynamic content that is created can be created to have such scrollable multiple views. FIG. 17 shows a non-limiting example of multiple-view dynamic content 91a-1-B which itself comprises both content 91a-1-A (from FIG. 15) and content 91a-1 (from FIG. 14). A finger F can be used to “swipe” the area of touch screen 202 that corresponds to dynamic content 91a to scroll between content 91a-1-A and content 91a-1. Those skilled in the art will recognize that the example in FIG. 17 would be generated at block 455 after performance of block 525 to create content 91a-1-B.

As another example, dynamic content 91a can comprise embedded links, which can be selected in order to activate a web page or other applications or other content associated with such links.

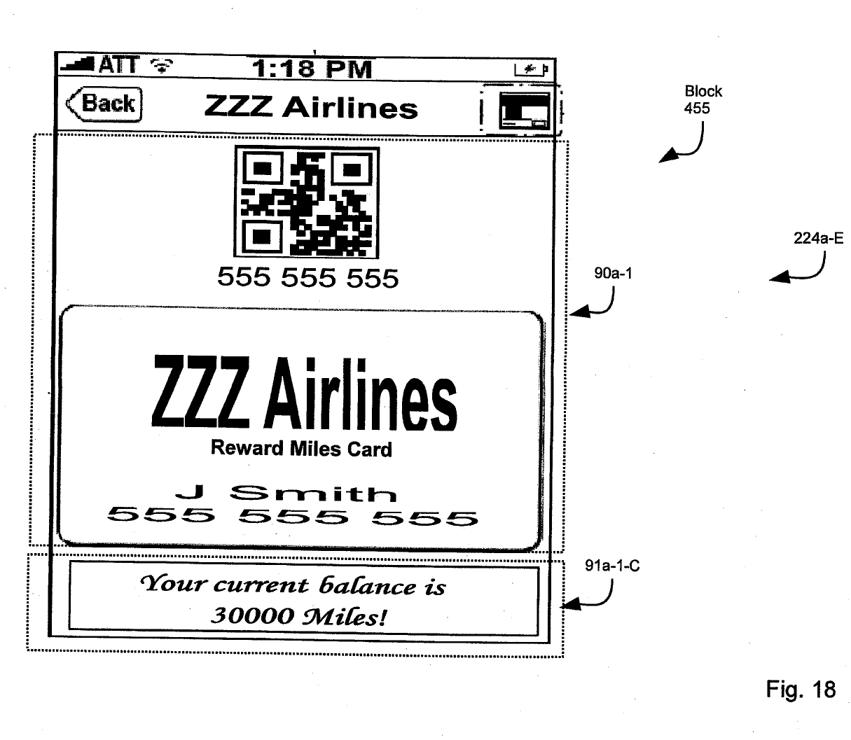

It will now be apparent that subsequent performances of method 500 can lead to continual updates to dynamic content 91a. For example, FIG. 18 shows an update to dynamic content 91a in the form of dynamic content 91a-1-C showing the miles balance for account 555 555 555 has increased from 27,000 miles to 30,000 miles.

A practical illustration will also now be apparent. Display 224a-B shown in FIG. 14, with dynamic content 91a-1 indicating a balance of 27,000 miles can be an initial state of system 50a. Display 224a-C shown in FIG. 15 can show the update to dynamic content 91a-1-A, in the form of a boarding pass that can be used to effect boarding of a plane for a booked flight. Assume that the flight is also “worth” 3,000 new miles. Therefore, immediately upon completion of the flight, link 66a can be reactivated leading to a performance of method 500 that updates dynamic content 91a-1-A to dynamic content 91a-1-C. Subsequent performance of method 400 results in generation of display 224a-E in FIG. 18, indicating that 3,000 more miles have now been added to account 555 555 555, bringing the total number of miles to 30,000 as shown in FIG. 18.

It is also to be understood that the types and nature of dynamic content 91a are not particularly limited, though are generally logically related or associated with a given record 90a. For example, where record 90a is a representation of an event ticket (discussed above), then dynamic content 91a can initially be a pre-event coupon for a restaurant outside the event, and during the event, the dynamic content 91a can change to a coupon for a concession stand within the event. Furthermore, the dynamic content may contain a barcode or other machine readable indicia to facilitate or track redemption of any service or other value associated with the dynamic content.

Table III below shows further examples of dynamic content.

TABLE III
Examples of records and dynamic content

| Example record 90a | Examples of dynamic content 91a |
|---|---|
| Airline “Air Miles” card | Reward balance |
| | Boarding pass |
| | Seat sales |
| Event ticket | Coupon for restaurant prior to event |
| | Coupon for venue within event |
| Retail Loyalty Card | Reward balance |
| | Coupons |
| Bank Debit Card | Financial Account Balance |
| | Mortgage rates |
| | Credit card rates |
| University | Campus announcements |
| Identification Card | Student loan application status |
| Employment benefits | Benefits claim redemption status tracking |
| card | Balance of personal health spending account |
| Retail gift card | Remaining balance on gift card |
| | Promotional offer to create a loyalty account. |
| | (e.g. bonus loyalty account points) |
| | Coupon redeemable in conjunction with gift |
| | card |
| Fan-club card for artist | Coupon offering for discount on media |
| or media program | release via DVD, CD or Itunes |
| | Schedule for upcoming live performance |
| | Opportunity to enter contest via SMS or other |
| | electronic message |

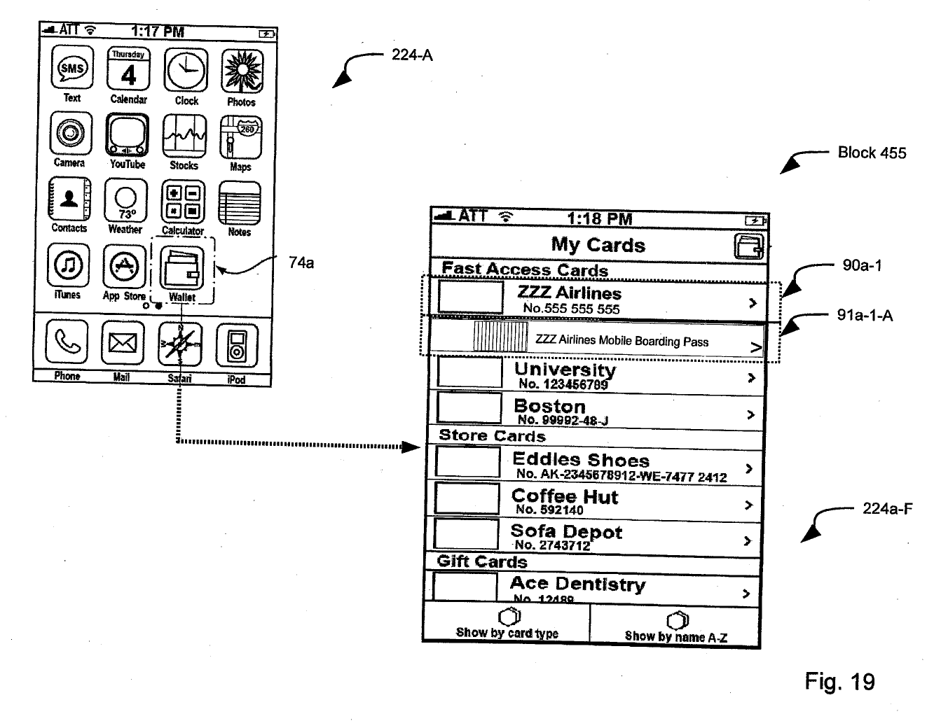

A further variation on the foregoing is shown in FIG. 19. In FIG. 19, display 224a-F is generated directly from display 224a. Display 224a-F is analogous to display 224-B and 224a-A, except that a link to dynamic content 91a-1-A is also included in relation to the link to record 90a-1. Method 400 can be varied in order to generate display 224a-F, where the invocation of the “wallet” application 74 from the menu on display 224-A results in deemed invocation of method 400 for every record 90a within application 74a. Accordingly, method 400 executes for every record 90a. As a simple example, only record 90a-1 has dynamic content 91a-1-A and so when the link for record 90a-1 is generated on display 224a-F, the link for dynamic content 91a-1-A is also generated on display 224a-F. To the extent other artifacts or records 90a have dynamic content 91a, then such dynamic content 91a can likewise be generated on display 224a-F.

It is to be understood that variations, sub-sets and combinations of the foregoing are contemplated, and that the scope of the exclusive privilege of this specification is defined by the claims. For example, as a variation of block 450, the contents of record 90a-1 can also be downloaded dynamically over network 58a, rather than being retrieved locally on device 54a-1.

1. A method for management of an electronic wallet database comprising:
receiving, at a portable electronic device, a selection of a data record corresponding to a wallet artifact, wherein said data record is locally stored on said portable electronic device;
identifying a server associated with said data record;
sending an identifier of said device to said server;
receiving dynamic content from an issuer server, wherein said issuer server is configured to maintain and retrieve dynamic content associated with said wallet artifact data record; and
controlling a display to generate said dynamic content and content from said data record.

2. The method of claim 1 wherein said server comprises said issuer server configured to issue said data record.

3. The method of claim 1 wherein said server comprises a central server configured to manage traffic between said issuer server and said electronic device.

4. The method of any claim 1, wherein said dynamic content comprises generic content.

5. The method of claim 4, wherein said generic content comprises an advertisement.

6. The method of claim 1, wherein said wallet artifact comprises one of a business card, a vanity card, a loyalty card, an identification card, a retail coupon, a manufacturers coupon, an event badge, a receipt, an event ticket, a subscriber pass, and a gift card.

7. The method of claim 1, wherein said wallet artifact comprises an Airline “Air Miles” card and said dynamic content comprises one or more of a reward balance, a boarding pass or a seat sale.

8. The method claim 1, wherein said wallet artifact comprises an event ticket and said dynamic content comprises one or more of a coupon for restaurant prior to event and a coupon for a venue within said event.

9. The method of claim 1, wherein said wallet artifact comprises a retail loyalty card, and said dynamic content comprises one or more of a reward balance and coupons.

10. A method claim 1, wherein said wallet artifiact comprises a bank debit card and said dynamic content comprises one or more of a financial account balance, mortgage rates, credit card rates.

11. The method of claim 1, wherein said wallet artifact comprises a university identification card and said dynamic content comprises one or more of campus announcements, and a student loan application status.

12. The method of claim 1, wherein said wallet artifact comprises an employment benefits card, and said dynamic content comprises one or more of a benefits claim redemption status tracking message, and a balance of personal health spending account.

13. A method of claim 1, wherein said wallet artifact comprises a retail gift card and said dynamic content comprises one or more of a remaining balance on said gift card, a promotional offer to create a loyalty account, and a coupon redeemable in conjunction with said gift card.

14. The method of claim 1, wherein said wallet artifact comprises a fan-club card for an artist or media program and said dynamic content comprises one or more of a coupon offering for discount on media release via DVD, CD or an online media store, a schedule for upcoming live performance, or a message offering an opportunity to enter a contest via SMS or other electronic message.

15. The method of claim 1, wherein communications between said server and said electronic device are conducted over a secure channel.

16. A portable electronic device comprising;
a memory storage unit; and
a processor connected to the memory storage unit, the processor configured to receive a selection of a data record corresponding to a wallet artifact, wherein said data record is locally storedin the memory storage unit;
said processor configured to identify a server associated with said data record;
said processor configured to send an identifier of said device to said server;
said processor configured to receive dynamic content from an issuer, server, wherein said issuer server is configured to maintain and retrieve dynamic content associated with said wallet artifact data record; and
said processor configured to control a display to generate said dynamic content and content from said data record.

17. A system comprising:
a server associated with a data record corresponding to a wallet artifact; and
a portable electronic device comprising:
a memory storage unit; and
a processor connected to the memory storage unit, the processor configured to receive a selection of said data record, wherein said data record is locally storedin the memory storage unit;
said processor configured to identify a server;
said processor configured to send an identifier of said device to said server;
said processor configured to receive dynamic content from an issuer server, wherein said issuer server is configured to maintain and retrieve dynamic content associated with said wallet artifact data record; and
said processor configured to control a display to generate said dynamic content and content from said data record.
